(19) United States
(12) Patent Application Publication
(10) Pub. No.: US 2022/0254123 A1
(43) Pub. Date: Aug. 11, 2022

(54) IMAGE PROCESSING APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Takabumi Watanabe, Tokyo (JP)

(21) Appl. No.: 17/729,099

(22) Filed: Apr. 26, 2022

Related U.S. Application Data
(63) Continuation of application No. 16/110,496, filed on Aug. 23, 2018.

(30) Foreign Application Priority Data
Aug. 31, 2017 (JP) 2017-167664

(51) Int. Cl. G06T 19/00; G06F 3/01; G06F 3/03; G06F 3/04842; G06F 3/04845; G06F 3/0482; G06V 10/44; G06V 40/20; G06V 40/10

(52) U.S. Cl. CPC G06T 19/006; G06F 3/011; G06F 3/0304; G06F 3/04842; G06F 3/017; G06V 10/46; G06F 3/0482; G06V 10/44; G06V 40/28; G06V 40/107; G06F 3/04845

(57) ABSTRACT

Out of a point group configuring a contour of a target object in a captured image, a point satisfying a predefined condition is selected as an operation point, and processing is executed based on the operation point.

### BACKGROUND OF THE INVENTION

### Field of the Invention

The present invention relates to a technique for presenting a mixed reality.

### Description of the Related Art

In recent years, research on mixed reality (MR) systems for the purpose of seamlessly joining physical spaces and virtual spaces has been actively conducted. As an image display apparatus for presentation in these systems, it is possible to use a head-mounted display (HMD), for example. In conjunction with progress in MR system research, masking techniques that aim to composite a physical object and a virtual object as in Japanese Patent Laid-Open No. 2002-157606 or Kenichi Hayashi, Hirokazu Kato, and Shogo Nishida, “Depth Determination of real objects using Contour Based Stereo Matching”, The Virtual Reality Society of Japan, Vol. 10, No. 3, pp. 371-380, 2005 have been proposed.

Furthermore, in order to solve the problem where the field of vision of a HMD apparatus user is covered and an operation switch cannot be seen, development is also progressing in gesture operation techniques where a masking technique is used to detect a body part such as a user's hand, and a virtual object is operated. Japanese Patent Laid-Open No. H8-6708 disclosed a technique for causing processing to activate after detecting, by a detecting unit that detects motion of an object, a predetermined motion of a part of a user's body that corresponds to a display element. Japanese Patent No. 5262681 discloses a technique for stacking and arranging virtual panels in a depth direction, detecting movement and a position in the depth direction of a hand, and selecting a predetermined panel from a plurality of virtual panels.

There are cases where for the methods of Japanese Patent Laid-Open No. 2002-157606 and Japanese Patent Laid-Open No. H8-6708, it is difficult to execute a real-time response that is required for an MR system with limited calculation resources, because they make determinations as to the movement of a hand or finger in addition to performing a recognition process for the hand or finger. In addition, because they are premised upon recognition of a hand or finger, operation is difficult in a situation where recognition of a shape of the hand or finger is unstable.

### SUMMARY OF THE INVENTION

The present invention was conceived in view of these kinds of problems, and provides a technique for more conveniently and stably detecting a target object in an image, and realizing execution of processing based on the detected target object.

According to the first aspect of the present invention, there is provided an image processing apparatus, comprising: a selection unit configured to, out of a point group configuring a contour of a target object in a captured image, select a point satisfying a predefined condition as an operation point; and a processing unit configured to execute processing based on the operation point.

According to the second aspect of the present invention, there is provided an image processing method that an image processing apparatus performs, the method comprising: out of a point group configuring a contour of a target object in a captured image, selecting a point satisfying a predefined condition as an operation point; and executing processing based on the operation point.

According to the third aspect of the present invention, there is provided a non-transitory computer-readable storage medium storing a computer program for causing a computer to function as a selection unit configured to, out of a point group configuring a contour of a target object in a captured image, select a point satisfying a predefined condition as an operation point; and a processing unit configured to execute processing based on the operation point.

Further features of the present invention will become apparent from the following description of exemplary embodiments (with reference to the attached drawings).

### BRIEF DESCRIPTION OF THE DRAWINGS

FIG. 1 is a block diagram for showing an example of a configuration of a system.

FIG. 2 is a flowchart for processing performed by an information processing apparatus 1000.

FIGS. 3A through 3D are views for describing processing in accordance with the flowchart of FIG. 2.

FIG. 4 is a flowchart for processing performed by the information processing apparatus 1000.

FIG. 5 is a view for describing processing in accordance with the flowchart of FIG. 4.

FIG. 6 is a flowchart for processing performed by the information processing apparatus 1000.

FIGS. 7A through 7D are views for describing processing in accordance with the flowchart of FIG. 6.

FIG. 8 is a flowchart for processing performed by the information processing apparatus 1000.

FIGS. 9A and 9B are views for describing processing in accordance with the flowchart of FIG. 8.

FIG. 10 is a flowchart for processing performed by the information processing apparatus 1000.

FIGS. 11A and 11B are views for describing processing in accordance with the flowchart of FIG. 10.

FIG. 12 is a flowchart for processing performed by the information processing apparatus 1000.

FIGS. 13A and 13B are views for describing processing in accordance with the flowchart of FIG. 12.

FIG. 14 is a flowchart for processing performed by the information processing apparatus 1000.

FIGS. 15A through 15C are views for describing processing in accordance with the flowchart of FIG. 14.

FIG. 16 is a block diagram illustrating an example of a hardware configuration of a computer apparatus.

FIG. 17 is a block diagram for showing an example of a configuration of a system.

FIG. 18 is a flowchart for processing performed by the information processing apparatus 1000.

FIGS. 19A and 19B are views for describing processing in accordance with the flowchart of FIG. 18.

FIG. 20 is a flowchart for processing performed by the information processing apparatus 1000.

FIGS. 21A and 21B are views for describing processing in accordance with the flowchart of FIG. 20.

### DESCRIPTION OF THE EMBODIMENTS

Below, explanation will be given for embodiments of present invention with reference to the accompanying drawing. Note that embodiments described below merely illustrate examples of specifically implementing the present invention, and are only specific embodiments of a configuration defined in the scope of the claims.

### First Embodiment

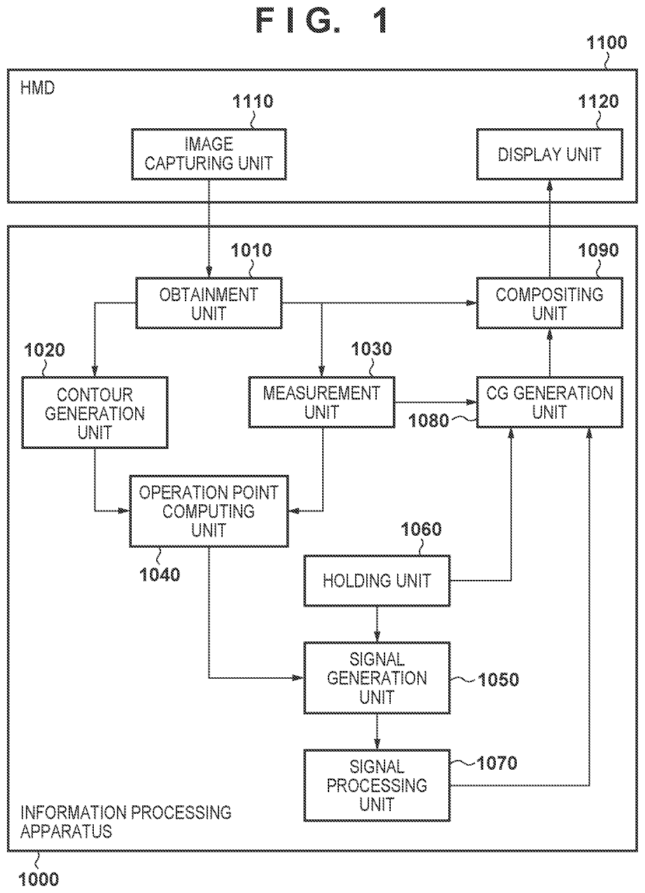

Firstly, using the block diagram of FIG. 1, description will be given regarding an example configuration of a system according to embodiments. As illustrated in FIG. 1, the system according to the present embodiment has an information processing apparatus 1000 that is a computer apparatus such as a PC (personal computer) or a tablet terminal device, and an HMD 1100 as an example of a head-mounted display. The information processing apparatus 1000 and the HMD 1100 are connected to as to be capable of data communication between each other, and, for example, are connected via a network such as a LAN or the Internet. Note that a connection configuration between the information processing apparatus 1000 and the HMD 1100 is not limited to a specific connection configuration, and may be wireless or wired, for example.

Firstly, description is given for the HMD 1100. An image capturing unit 1110 has a left-eye image capturing unit (a left viewpoint) for capturing an image (a left-eye image) of a physical space to provide to a left eye of a user who wears the HMD 1100 on their head, and a right-eye image capturing unit (a right viewpoint) for capturing an image (a right-eye image) of the physical space to provide to the right eye of the user. Each of the left-eye image capturing unit and the right-eye image capturing unit may be an image capturing unit that captures still images, and may be an image capturing unit that captures a moving image. The image capturing unit 1110 sends, as a stereo image, a set of a left-eye image captured by the left-eye image capturing unit and a right-eye image captured by the right-eye image capturing unit to the information processing apparatus 1000 (in other words, the stereo image may be still images, and may be moving images).

A display unit 1120 has a left-eye display unit for providing text or an image to the left eye of a user who wears the HMD 1100 on their head, and a right-eye display unit for providing text or an image to the right eye of the user. The left-eye display unit and the right-eye display unit are respectively attached to the HMD 1100 so as to be positioned before the left eye and the right eye or the user who wears the HMD 1100 on their head, and display images and text sent from the information processing apparatus 1000.

Next, description is given regarding the information processing apparatus 1000. The information processing apparatus 1000 is an apparatus that functions as an image processing apparatus that can execute various processing that is described later. An obtainment unit 1010 receives a stereo image sent from the image capturing unit 1110. A contour generation unit 1020 obtains a three-dimensional position of each point that configures a contour of a target object (a physical object user by the user for performing some kind of operation, such as a person's hand) appearing in the stereo image (in a captured image) received by the obtainment unit 1010.

A measuring unit 1030 uses a left-eye image received by the obtainment unit 1010 to obtain a position and orientation of the left viewpoint in a world coordinate system (a coordinate system that takes one point in a physical space as an origin point, and three axes orthogonal to one another at the origin point as an x axis, a y axis, and a z axis, respectively). Furthermore, the measuring unit 1030 uses a right-eye image received by the obtainment unit 1010 to obtain a position and orientation of the right viewpoint in the world coordinate system. For example, based on a feature point appearing in an image (a marker that a person intentionally arranged in the physical space, a natural feature originally present in the physical space, or the like) the measuring unit 1030 calculates the position and orientation of the image capturing unit that captured the image. Note that there are various methods for obtaining the position and orientation of an image capturing unit in a world coordinate system, and there is no limitation to a specific method. For example, configuration may be taken to attach to the HMD 1100 a sensor whose position and orientation relative to image capturing units (the left-eye image capturing unit and the right-eye image capturing unit) is known beforehand, and convert a measurement value by the sensor based on the relative position and orientation to thereby obtain the position and orientation of the image capturing unit in a world coordinate system. In addition, the position and orientation of an image capturing unit in a world coordinate system may be obtained in accordance with a method that uses a motion capture system, a method that uses Simultaneous Localization and Mapping (SLAM) that uses a captured image, or the like.

An operation point computing unit 1040 selects, as an operation point, a point that satisfies a predefined condition from among each point that configures the aforementioned contour. In the present embodiment, the operation point computing unit 1040 selects as an operation point a point that is positioned most upward in an image in a row direction, out of each point that configures the aforementioned contour.

A signal generation unit 1050 generates, based on a motion or a three-dimensional position of an operation point, a motion or a position of the operation point relative to a predefined virtual object, or the like, a signal that is to be a trigger for executing predefined processing, and sends the signal to a signal processing unit 1070. In the present embodiment, in the case where a pointer arranged at the position of an operation point comes into contact with a predefined portion in a button (a virtual object), it is determined that the button has been pressed, and the signal to be a trigger for executing the predefined processing is generated and sent to the signal processing unit 1070. However, a condition for generating the signal that is to be a trigger for executing predefined processing is not limited to a specific condition. For example, configuration may be taken such that, in a case where temporal change of a three-dimensional position (may be an absolute position, or may be a relative three-dimensional position with respect to a predefined virtual object) of an operation point is recognized as a predefined gesture, the signal to be the trigger for executing the predefined processing is generated and sent to the signal processing unit 1070. The signal processing unit 1070 executes processing that corresponds to the signal sent from the signal generation unit 1050.

A holding unit 1060 holds rendering data of each virtual object (a CG model) arranged in the virtual space. Rendering data of a virtual object is data necessary for rendering the virtual object. For example, in a case where a virtual object is configured by polygons, the rendering data of the virtual object includes data such as the color, material, or a normal vector of a polygon, three-dimensional positions of each vertex that configures a polygon, a texture to map onto the polygon, and a position and orientation in a world coordinate system of the virtual object. A virtual object arranged in the virtual space includes the aforementioned button, and a pointer arranged at a three-dimensional position of an operation point to allow a user to see the three-dimensional position of the operation point.

A CG generation unit 1080 uses the rendering data of each virtual object held in the holding unit 1060 to construct the virtual object and arrange it in the virtual space. The CG generation unit 1080 generates an image of the virtual space seen from a left viewpoint (a left-eye virtual space image), based on the position and orientation of the left viewpoint in the world coordinate system obtained by the measuring unit 1030. Additionally, the CG generation unit 1080 generates an image of the virtual space seen from a right viewpoint (a right-eye virtual space image), based on the position and orientation of the right viewpoint in the world coordinate system obtained by the measuring unit 1030. Because a technique for generating an image of a virtual space seen from a viewpoint having a predefined position and orientation is well-known, description for this technique is omitted.

A compositing unit 1090 generates, as a left-eye mixed reality space image, a composite image in which the left-eye virtual space image is caused to be overlaid on the left-eye image received by the obtainment unit 1010. Additionally, the compositing unit 1090 generates, as a right-eye mixed reality space image, a composite image in which the right-eye virtual space image is caused to be overlaid on the right-eye image received by the obtainment unit 1010. At this point, in a case of causing a virtual space image to be overlaid on a portion or all of an image region where a target object appears in the left-eye image and the right-eye image, respectively, consideration is given for depth between the target object and the virtual object, and an occlusion relationship between the objects is made to correspond. In other words, in an image region of a target object, overlapping of the virtual space image is permitted for a partial region where a virtual object that overlaps is closer to a viewpoint than the target object. In contrast, in an image region of a target object, overlapping of the virtual space image is prohibited for a partial region where a virtual object that overlaps is further from a viewpoint than the target object.

The compositing unit 1090 sends the image of the mixed reality space for the left eye to the left-eye display unit held by the display unit 1120 of the HMD 1100, and also sends the image of the mixed reality space for the right eye to the right-eye display unit held by the display unit 1120 of the HMD 1100.

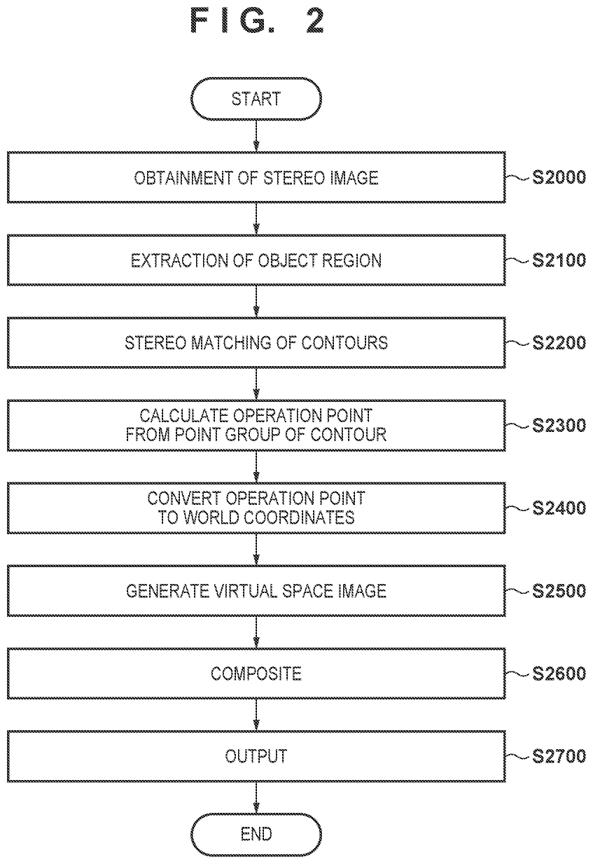

Next, description is given in accordance with the flowchart of FIG. 2 regarding processing the information processing apparatus 1000 performs in order to generate one frame's worth of mixed reality space images (a left-eye mixed reality space image and a right-eye mixed reality space image), and output them to the display unit 1120. Note that, by repeatedly performing processing in accordance with the flowchart of FIG. 2, it is possible to generate a plurality of frames of mixed reality space images and send them to the HMD 1100.

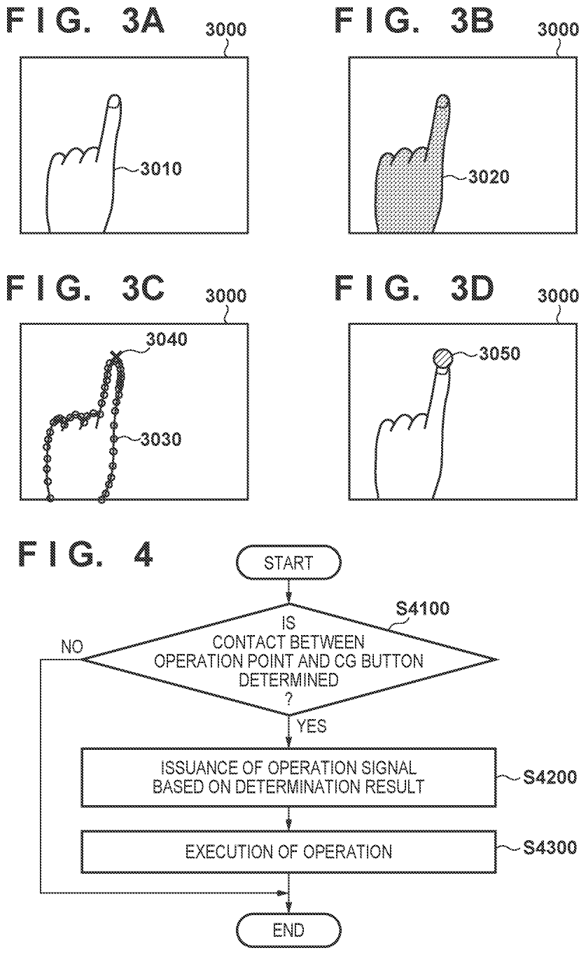

In step S2000, the obtainment unit 1010 receives a stereo image sent from the image capturing unit 1110. In step S2100, from each of the left-eye image and the right-eye image included in the stereo image, the contour generation unit 1020 extracts a contour (a two-dimensional contour) of a target object in the image. For example, as illustrated in FIG. 3A, in a case of extracting a two-dimensional contour of a hand 3010 of a person from an image 3000 that includes the hand 3010 as a target object, from a captured image resulting from capturing the hand in advance, color information in an image region of the hand is extracted and registered in a table in advance. The color information may be RGB, and may be represented by YCbCr luminance and tint information. The method for obtaining the two-dimensional contour is not limited to the above method and a segmentation method using a graph cut or machine learning may be used. As illustrated by FIG. 3B, a contour 3020 of an image region having the color information that was registered in the table in advance is extracted from the image 3000 as the two-dimensional contour of the hand 3010.

In step S2200, the contour generation unit 1020 matches the two-dimensional contour extracted from the left-eye image and the two-dimensional contour extracted from the right-eye image to generate a three-dimensional contour of the target object. A method of generating a three-dimensional contour is not limited to a specific method, and, for example, it is possible to apply the method disclosed in Kenichi Hayashi, Hirokazu Kato, and Shogo Nishida, “Depth Determination of Real Objects using Contour Based Stereo Matching”, The Virtual Reality Society of Japan, Vol. 10, No. 3, pp. 371-380, 2005. In other words, an epipolar line corresponding to a sampling point on a two-dimensional contour on one image, out of the left-eye image and the right-eye image included in the stereo image, is projected onto the other image, and a point where the epipolar line and the two-dimensional contour intersect is taken as a corresponding point. A plurality of sampling points on the two-dimensional contour are decided, and a plurality of corresponding points on the two-dimensional contour are obtained. A depth value for each of the plurality of corresponding points on the two-dimensional contour are calculated by triangulation.

Next, in step S2300, the operation point computing unit 1040 selects, as an operation point, a corresponding point having coordinate values that are most upward in the row direction, in the image for which corresponding points were obtained. For example, as illustrated by FIG. 3C, a corresponding point 3040 having coordinate values most upward in the row direction, out of corresponding points (indicated by “o”) on a three-dimensional contour 3030 which corresponds to the contour 3020 of FIG. 3B, is selected as the operation point. Note that, when there are a plurality of real-space objects that can be operation points, one real-space object may be selected for the extraction of an operation point.

In the present embodiment, from a plurality of three-dimensional contours obtained from a plurality of real-space objects, a three-dimensional contour to which a feature point present most upward in the row direction in an obtained image, from feature points obtained by a method similar to the calculation of the operation point 3040, belongs is selected. A method for selecting one real-space object in order to extract an operation point may alternatively use various features such as an average position of a vertex group or a number of vertices of a three-dimensional contour, the position of a centroid, or the area of a three-dimensional curved surface formed by the three-dimensional contour.

In step S2400, the operation point computing unit 1040 converts the three-dimensional position of the operation point, in other words the three-dimensional position in a coordinate system based on the position and orientation of the image capturing unit that captured the image for which the corresponding points were obtained, to a three-dimensional position in the world coordinate system, based on the position and orientation of the image capturing unit.

In step S2500, the measuring unit 1030 uses the left-eye image to obtain the position and orientation of the left viewpoint in the world coordinate system, and also uses the right-eye image to obtain the position and orientation of the right viewpoint in the world coordinate system. The CG generation unit 1080 uses the rendering data of each the virtual object held in the holding unit 1060 to construct the virtual object and arrange it in the virtual space.

At this time, the CG generation unit 1080 arranges a pointer at the three-dimensional position of the operation point in the world coordinate system. A virtual object used as the pointer is not limited to a specific virtual object. Furthermore, the CG generation unit 1080 arranges the aforementioned button in the virtual space with a predefined position and orientation. The CG generation unit 1080 generates an image of the virtual space seen from the left viewpoint (a left-eye virtual space image), and generates an image of the virtual space seen from the right viewpoint (a right-eye virtual space image).

In step S2600, the compositing unit 1090 generates, as a left-eye mixed reality space image, a composite image in which the left-eye virtual space image is caused to be overlaid on the left-eye image. Additionally, the compositing unit 1090 generates, as a right-eye mixed reality space image, a composite image in which the right-eye virtual space image is caused to be overlaid on the right-eye image. By this, as illustrated by FIG. 3D, for example, it is possible to cause the pointer 3050 to be overlaid on the position of the corresponding point 3040 in the image 3000.

In in step S2700, the compositing unit 1090 sends the image of the mixed reality space for the left eye to the left-eye display unit held by the display unit 1120 of the HMD 1100, and also sends the image of the mixed reality space for the right eye to the right-eye display unit held by the display unit 1120 of the HMD 1100.

Next, description in accordance with the flowchart of FIG. 4 is given for processing for determining contact between an operation point and a button. Note that processing in accordance with the flowchart of FIG. 4 may be performed as part of processing in accordance with the flowchart of FIG. 2, and may be performed as another thread.

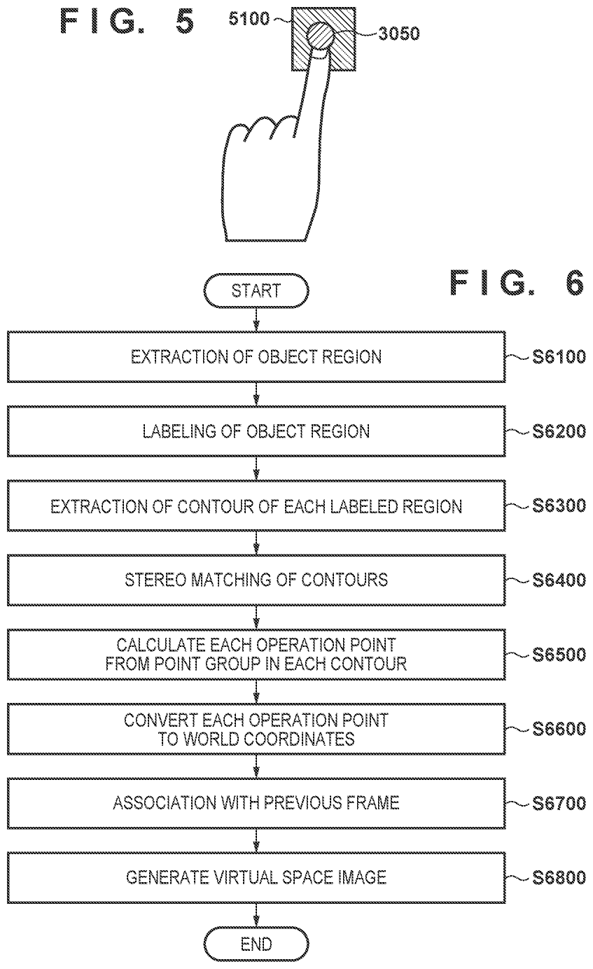

In step S4100, the signal generation unit 1050 determines whether the button and the pointer arranged at the three-dimensional position of the operation point have come into contact. Various methods can be applied to a method for determining contact between a pointer and a button. For example, as illustrated by FIG. 5, in a case where a line segment joining a three-dimensional position of the pointer 3050 in a previous frame and a three-dimensional position of the pointer 3050 in the current frame intersects with any polygon configuring a button 5100, it is determined that the pointer 3050 and the button 5100 are in contact. In addition, a three-dimensional region that includes the position of the pointer 3050 is set, and in a case where a line segment or surface that configures the three-dimensional region intersects with any polygon that configures the button 5100, it is determined that the pointer 3050 and the button 5100 are in contact.

As a result of such a determination, when it is determined that the pointer and the button are in contact, the processing advances to step S4200, and when it is not determined that they are in contact, the processing returns to step S4100.

In step S4200, the signal generation unit 1050 generates a signal for executing processing that is set in advance as processing to execute when the button is pressed, and sends the generated signal to the signal processing unit 1070. In step S4300, the signal processing unit 1070 executes processing that corresponds to the signal received from the signal generation unit 1050.

### Second Embodiment

Including the present embodiment, differences with the first embodiment are described below, and unless otherwise touched on in particular below, it is assumed to be similar to the first embodiment. In the first embodiment, the number of operation points to be selected was given as one, but the number of operation points to be selected may be two or more. By setting the number of selectable operation points to two or more and, for each operation point, enabling processing in accordance with a motion or a position of the operation point to be executed, it is possible to increase types of operations in accordance with a target object to be more than in the first embodiment. In the present embodiment, processing in accordance with the flowchart of FIG. 6 is performed instead of the foregoing step S2100 through step S2500 in the flowchart of FIG. 2.

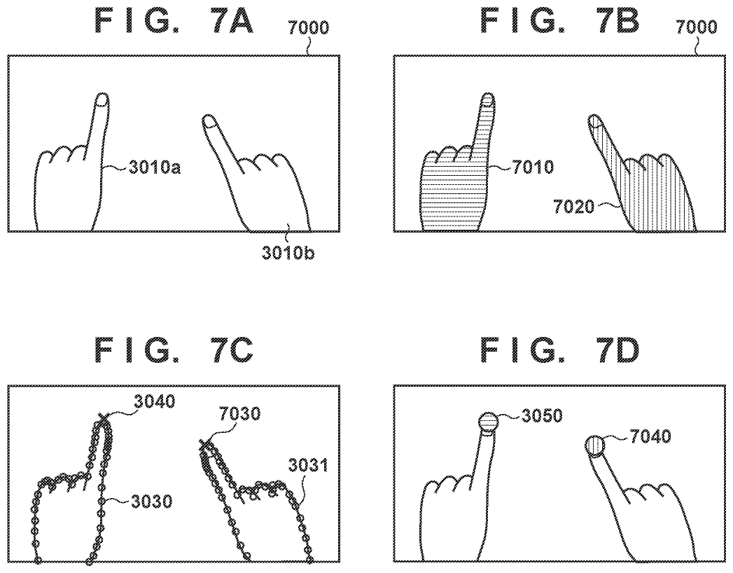

In step S6100, from each of the left-eye image and the right-eye image included in the stereo image, the contour generation unit 1020 extracts an image region of a target object in the image. For example, as illustrated by FIG. 7A, from an image 7000 that includes hands 3010a and 3010b of a person as target objects, an image region for each of the hands 3010a and 3010b is extracted. For a method of extracting the image region of a hand, similarly to step S2100 described above, an image region having color information of a hand that is registered in advance is extracted.

In step S6200, in a case where there are a plurality of pixels having the color information of the hand, the contour generation unit 1020 performs a labeling process for each pixel. In a case where extracted pixels that were extracted as pixels having the color information of the hand in step S6100 are adjacent to each other, the same label is added to these pixels. By performing a labeling process with respect to the image 7000 of FIG. 7A, as illustrated by FIG. 7B, a label A is added to each pixel belonging to an image region 7010 of the hand 3010a, and a label B that is different to the label A is added to each pixel belonging to an image region 7020 of the hand 3010b.

In step S6300, for each labeled image region, the contour generation unit 1020, similarly to in step S2100 described above, extracts a two-dimensional contour of the image region.

In step S6400, the contour generation unit 1020 performs processing similar to step S2200 described above to thereby associate a two-dimensional contour of an image region of interest in one image with a two-dimensional contour of an image region corresponding to the image region of interest in the other image. For each pair of associated two-dimensional contours, the contour generation unit 1020 uses the two-dimensional contours belonging to the pair to perform processing similar to step S2200 described above to thereby obtain a point group that configures a three-dimensional contour of a target object that corresponds to the pair.

In step S6500, for each aforementioned pair, the operation point computing unit 1040 selects, as an operation point, a point that satisfies a predefined condition out of the point group obtained in step S6400 for the pair, similarly to in step S2300 described above. FIG. 7C illustrates the corresponding point 3040 selected as an operation point out of the point group that configures the three-dimensional contour 3030 which corresponds to the image region 7010, and a point 7030 selected as an operation point out of the point group that configures a three-dimensional contour 3031 which corresponds to the image region 7020.

In step S6600, for each operation point, the operation point computing unit 1040 performs processing similar to that of step S2400 described above to thereby convert the three-dimensional position of the operation point to a three-dimensional position in the world coordinate system.

In step S6700, the operation point computing unit 1040 associates the operation points in the previous frame and the operation points in the current frame with each other for operation points of the same target object to thereby guarantee continuity. For example, distances between the three-dimensional positions of respective operation points obtained for the previous frame and three-dimensional positions of respective operation points obtained for the current frame are obtained. An operation point of interest in the current frame is associated with, out of operation points in the previous frame, an operation point at a three-dimensional position closest to the three-dimensional position of the operation point of interest. A method of association may use estimation information such as speed information or a Kalman filter.

In step S6800, processing similar to step S2500 described above is performed, but, for each operation point, the CG generation unit 1080 arranges a pointer at the three-dimensional position of the operation point in the world coordinate system. By this, for example, as illustrated by FIG. 7D, it is possible to overlay the pointer 3050 at the position of the corresponding point 3040 in the image 3000, and overlay a pointer 7040 at the position of the point 7030 as an operation point.

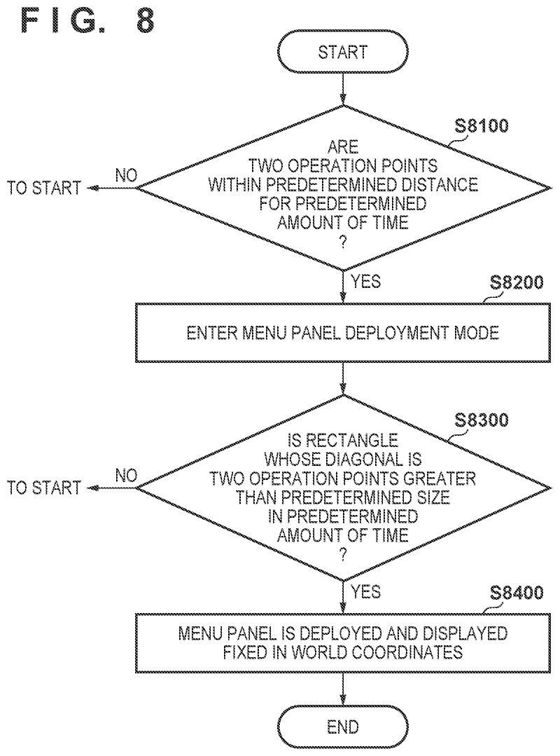

Next, description in accordance with the flowchart of FIG. 8 is given for processing performed in accordance with the positions of two pointers. Note that processing in accordance with the flowchart of FIG. 8 may be performed as part of processing described above, and may be performed as another thread.

In step S8100, the signal generation unit 1050 determines whether a condition of a state, in which two pointers are arranged in the virtual space and a distance between the two pointers is less than or equal to a predefined distance, continuing for a predetermined amount of time or more is satisfied. If a result of this determination is that this condition is satisfied, the processing advances to step S8200, and if this condition is not satisfied, the processing returns to step S8100.

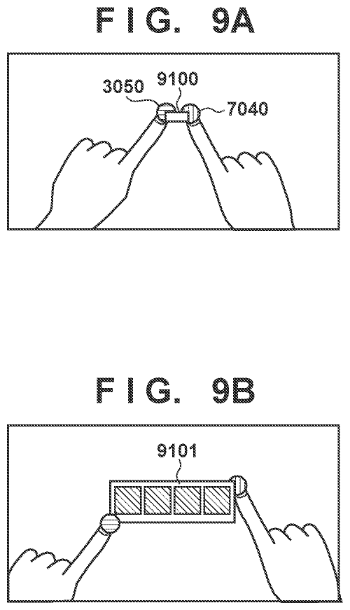

In step S8200, the signal generation unit 1050 turns on a mode for deploying a menu panel (a menu panel deployment mode). Note that, if the aforementioned condition is not satisfied, the signal generation unit 1050 turns this menu panel deployment mode off. When the menu panel deployment mode is turned on, as illustrated in FIG. 9A, a rectangular object 9100 positioned at end portions of a diagonal line positioned on the images of the two pointers—the pointer 3050 and the pointer 7040, is overlapped on the mixed reality space image. The object 9100 is an object for indicating that a menu panel is deploying.

Here, when the menu panel deployment mode is turned on, the signal generation unit 1050 generates and sends to the signal processing unit 1070 a signal for instructing generation of the object 9100. Upon receiving such a signal, the signal processing unit 1070 instructs the CG generation unit 1080 to generate the rectangular object 9100. Note that a positional relationship between the rectangular object 9100 and the two pointers is not limited to a positional relationship as illustrated in FIG. 9A.

In step S8300, the signal generation unit 1050 determines whether a condition of the distance between the two pointers being greater than or equal to a predefined distance is satisfied. If a result of this determination is that this condition is satisfied, the processing advances to step S8400, and if this condition is not satisfied, the processing returns to step S8100.

In step S8400, the signal generation unit 1050 generates and sends to the signal processing unit 1070 a signal for instructing to arrange the menu panel on a surface where an average position of the positions of the two pointers is taken as a center position, and a vector parallel to a line-of-sight vector of an image capturing unit is taken as a normal vector. Here, the line-of-sight vector of an image capturing unit may be a line-of-sight vector of either of the right-eye image capturing unit and the left-eye image capturing unit, and may be a mean vector of a line-of-sight vector of the right-eye image capturing unit and a line-of-sight vector of the left-eye image capturing unit. By this, as illustrated in FIG. 9B for example, the signal processing unit 1070 instructs the CG generation unit 1080 to arrange a menu panel 9101 on a surface where an average position of the positions of the two pointers is taken as a center position and a vector parallel to a line-of-sight vector of an image capturing unit is taken as a normal vector.

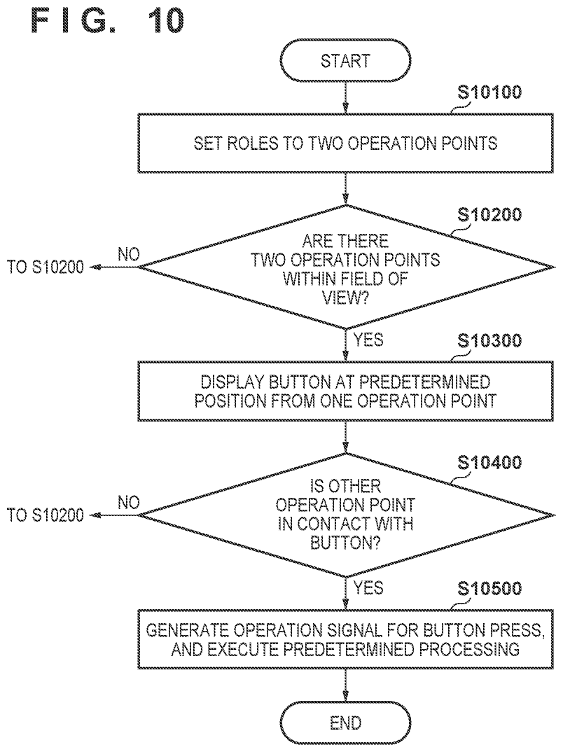

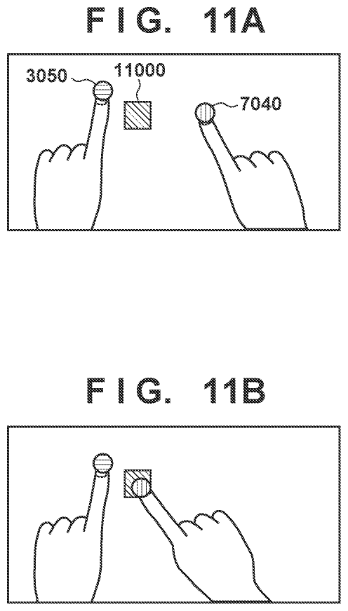

Next, description in accordance with the flowchart of FIG. 10 is given regarding separate processing that is performed in accordance with the positions of the two pointers. Note that processing in accordance with the flowchart of FIG. 10 may be performed as part of processing described above, and may be performed as another thread. In the processing in accordance with the flowchart of FIG. 10, unique processing is assigned for each operation point, and when a pointer corresponding to the operation point satisfies a predefined condition, the processing assigned to the operation point is executed.

In step S10100, the signal generation unit 1050 sets a role corresponding to each operation point. For example, a first role is set to an operation point positioned in a left half of an image, and a second role different to the first role is set to an operation point positioned in a right half of the image. The method of setting a role may be to cause a user to set it via a GUI, may be to set it in advance, or may be to set it in accordance with a usage condition of the HMD 1100.

In the present embodiment, pressing a menu for entering this processing is assumed as a step prior to this processing, and the aforementioned button is displayed near an operation point (operation point A) where the menu was pressed, and the other operation point (the operation point B) is treated as an operation point for pressing the button. Here, in step S10100, a role of “nearby button display” is set for the operation point A, and a role of “button press” is set for the operation point B.

In step S10200, the signal generation unit 1050 determines whether a condition of three-dimensional positions of the two operation points being positioned in the field of view of the image capturing unit 1110 (the left-eye image capturing unit and the right-eye image capturing unit) is satisfied. If a result of this determination is that this condition is satisfied, the processing advances to step S10300, and if this condition is not satisfied, the processing returns to step S10200.

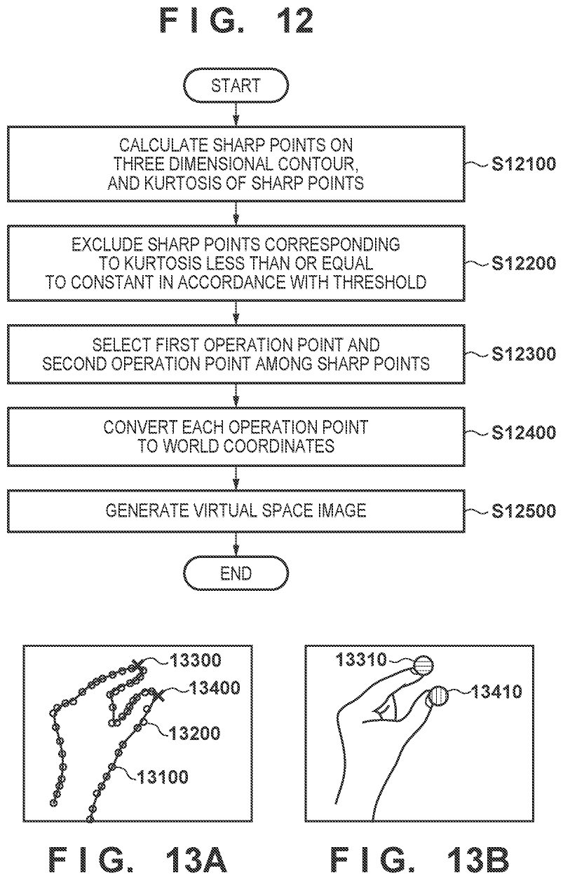

In step S10300, the signal generation unit 1050 generates and sends to the signal processing unit 1070 a signal for instructing the arrangement of a button near the three-dimensional position of the operation point A. By this, the signal processing unit 1070 instructs the CG generation unit 1080 to arrange a button near the three-dimensional position of the operation point A, and therefore, as illustrated by FIG. 11A, a button 11000 is arranged near the pointer 3050, which corresponds to the operation point A, on the mixed reality space image.

In step S10400, similarly to step S4100 described above, the signal generation unit 1050 determines whether the pointer corresponding to the operation point B is in contact with the button. A situation where a pointer and a button are in contact is illustrated in FIG. 11B. As a result of such a determination, when it is determined that the pointer and the button are in contact, the processing advances to step S10500, and when it is not determined that they are in contact, the processing returns to step S10200.

In step S10500, the signal generation unit 1050 generates a signal for executing processing that is set in advance as processing to execute when the button is pressed, and sends the generated signal to the signal processing unit 1070. The signal processing unit 1070 executes processing that corresponds to the signal received from the signal generation unit 1050.

Note that, in the present embodiment, the number of hands as target objects for which operation points can be set was given as two. However, the number of target objects for which operation points can be set may be two or more. In such a case, the number of operation points that are selected is assumed to be two or more.

### Third Embodiment

In the first and second embodiments, one operation point is set with respect to one target object, but the number of operation points that can be set for one target object may be two or more. For example, because a greater variety of operations can be realized in the case of using a plurality of fingers in comparison to the case of using one finger, there is significance in setting operation points for a plurality of fingers in one hand, and executing processing in accordance with, for example, the respective position or motion of the set operation points. In the present embodiment, processing in accordance with the flowchart of FIG. 12 is performed instead of the foregoing step S2300 through step S2500 in the flowchart of FIG. 2.

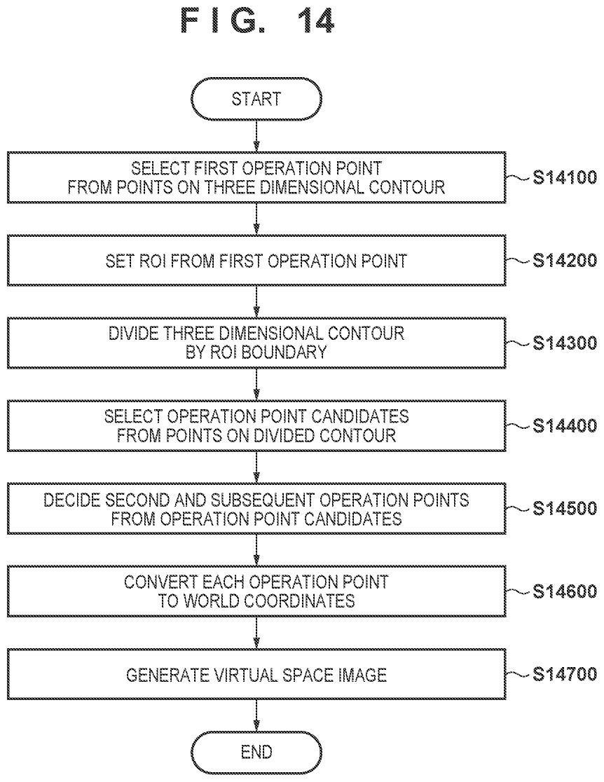

In step S12100, the operation point computing unit 1040 obtains a degree of projection (kurtosis) of a sharp point present in a point group that configures a three-dimensional contour. For example, as illustrated by FIG. 13A, the kurtosis for a sharp point 13200 present in a point group 13100 that configures a three-dimensional contour is obtained. Convex hull processing is performed after projecting a point group on the three-dimensional contour onto the image, and the sharp point 13200 defines a common point among points of the obtained convex hull, and each point of the projected contour. Note that the method for obtaining the sharp point is not specifically limited. A low-pass filter may be performed with respect to a projected contour, as preprocessing for convex hull generation. Next, for each point of the projected contour, with the obtained the sharp point as an origin, a predetermined number of points are selected from each side thereof, and from the point at one end to the point at the other end, a sum total of angles formed between a line segment configured by the (n−1)-th and n-th points and a line segment configured by the n-th and (n+1)-th points is obtained. This value is defined as the kurtosis. Note that there are other definitions for kurtosis, and, for example, something obtained by dividing the kurtosis described above by a total of distances of the set of line segments configured by adjacent points from among the points from one end until the other end may be made to be the kurtosis.

In step S12200, the operation point computing unit 1040 sets a sharp point for which the kurtosis is greater than or equal to a threshold as a target sharp point that is to be a target of the following processing, and excludes a sharp point for which the kurtosis is less than the threshold from the following processing. Note that, it is possible to set all sharp points as target sharp points if this threshold is set to 0. In addition, configuration may be taken to obtain the kurtosis for each point of the three-dimensional contour, and set a point for which the kurtosis is greater than or equal to a threshold as a target sharp point.

In step S12300, the operation point computing unit 1040 selects two target sharp points from the target sharp point group. Selection conditions for selecting two sharp points from a target sharp point group are not limited to specific conditions. In the present embodiment, out of the target sharp points, in a case of projecting onto an image (either of the left-eye image or the right-eye image), sharp points having coordinate values most upward in the row direction and second most upward in the row direction are respectively selected as the first operation point and the second operation point. For example, in a case where the point group 13100 as illustrated in FIG. 13A is obtained, the sharp point 13300 having the most upward coordinate values is selected as the first operation point, and the sharp point 13400 having the second most upward coordinate values is selected as the second operation point. Note that configuration may be taken to select the sharp point for which kurtosis is the highest as the first operation point and the sharp point for which the kurtosis is the next highest as the second operation point, and configuration may be taken to decide an operation point by considering both of coordinate values and kurtosis.

In step S12400, the operation point computing unit 1040 performs processing similar to step S2400 described above for each of the first operation point and the second operation point to thereby convert the three-dimensional position at each of the first operation point and the second operation point to a three-dimensional position in the world coordinate system.

In step S12500, processing similar to step S2500 described above is performed, but, for each of the first operation point and the second operation point, the CG generation unit 1080 arranges a pointer at the three-dimensional position of the operation point in the world coordinate system. By this, for example, as illustrated in FIG. 13B, it is possible to cause the pointer 13310 to overlap the position of the first operation point in the image, and cause the pointer 13410 to overlap the position of the second operation point.

The signal generation unit 1050 generates and sends to the signal processing unit 1070 a signal that is a trigger for performing processing in accordance with motion or the three-dimensional position of each operation point, and the signal processing unit 1070 controls the CG generation unit 1080 to perform processing in accordance with the signal. Note that there is no limit to processing in accordance with the motion or position of an operation point, and information of the motion, or the orientation or position of each operation point may be used, and information of relative motion, orientation, or position among a plurality of operation points may be used. Furthermore, information of a contact state with another virtual object, or a relative position, orientation, or motion between a virtual object and each operation point may be used.

### First Variation of Third Embodiment

In the present variation, description is given regarding a calculation method different to the method of calculating a plurality of operation points that was described in the third embodiment. In the present variation, processing in accordance with the flowchart of FIG. 14 is performed instead of the foregoing step S2300 through step S2500 in the flowchart of FIG. 2.

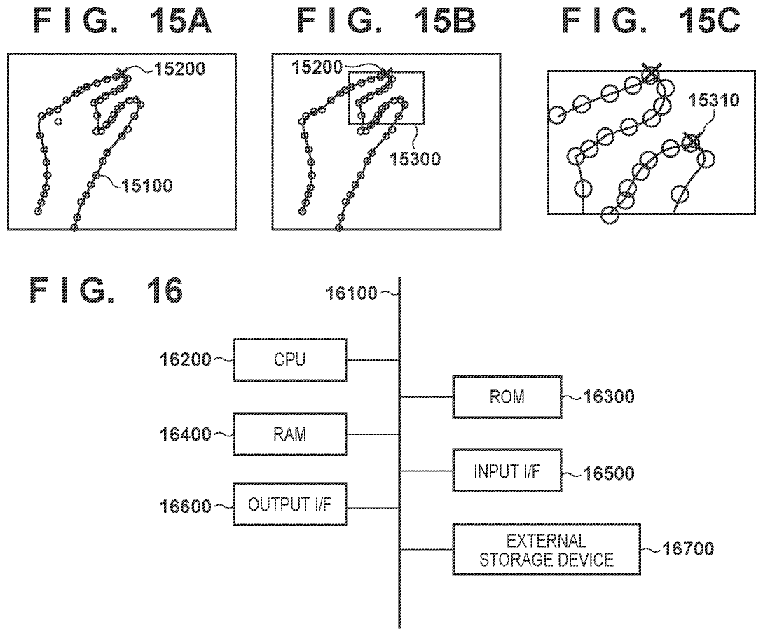

In step S14100, the operation point computing unit 1040 selects one point from the sharp points on the three-dimensional contour as a first operation point. A condition for selecting the first operation point is not limited to a specific selection condition, but, in the present embodiment, it is assumed that the first operation point is selected similarly to in the third embodiment. For example, as illustrated in FIG. 15A, a first operation point 15200 is selected from a point group 15100 similarly to in the third embodiment.

In step S14200, the operation point computing unit 1040 sets an ROI (region of interest) on an image (either of the left-eye image or the right-eye image), based on the first operation point. For example, as illustrated in FIG. 15B, each point on a three-dimensional contour is projected onto the image, and a rectangular region 15300 that takes the position of the first operation point 15200, from among the projected points, as the center point of a top side is set as an ROI.

In step S14300, the operation point computing unit 1040 divides, in accordance with the boundaries of the ROI, the contour configured by the points projected onto the image. For example, as illustrated by FIG. 15C, when a line segment configured by adjacent points on the contour crosses a boundary of the ROI, points outside of the ROI are excluded, and the contour is divided.

In step S14400, the operation point computing unit 1040 selects an operation point candidate from points on each contour in the ROI. A method for selecting a candidate for a contour is not limited to a specific method, but, in the present embodiment, for each contour in the ROI, a point most upward in the row direction in the image out of points on the contour is set as an operation point candidate.

In step S14500, the operation point computing unit 1040 decides a predefined number of operation points from the operation point candidates, as in a second operation point, a third operation point, . . . . A method of deciding an operation point is not limited to a specific method, but, in the present embodiment, a predefined number of operation points, as in a second operation point, a third operation point, . . . , are decided in order from candidates that are upward in the row direction on the image, out of operation point candidates.

In step S14600, for each operation point, the operation point computing unit 1040 performs processing similar to that of step S2400 described above to thereby convert the three-dimensional position of the operation point to a three-dimensional position in the world coordinate system.

In step S14700, processing similar to step S2500 described above is performed, but, for each operation point, the CG generation unit 1080 arranges a pointer at the three-dimensional position of the operation point in the world coordinate system.

### Second Variation of Third Embodiment

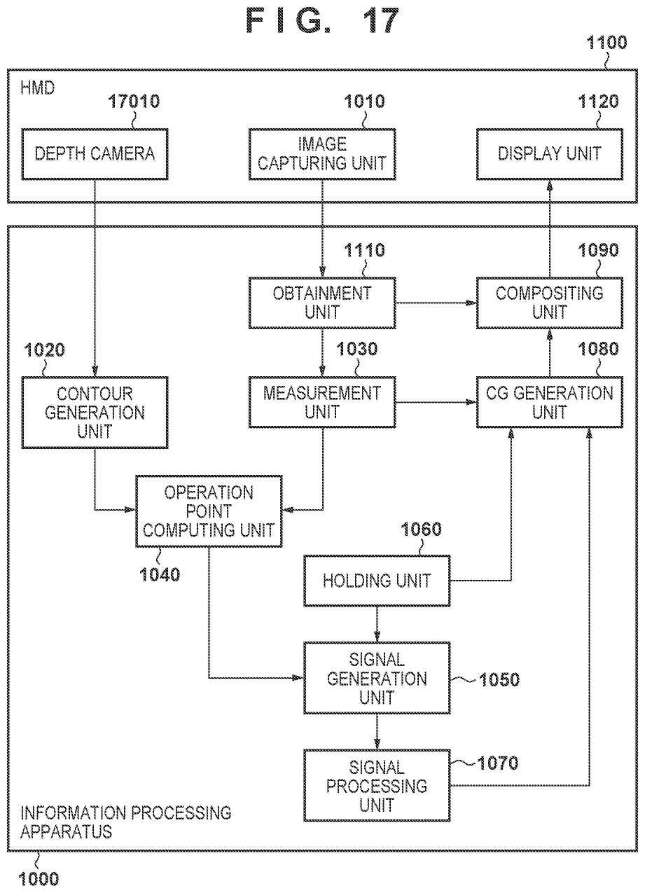

In each of the embodiments or variations described above, the three-dimensional contour of a target object is obtained by using a stereo image, but a method for obtaining a three-dimensional contour of a target object is not limited to a specific method. For example, as illustrated by FIG. 17, a depth camera 17010 is mounted on the HMD 1100, and is caused to capture a depth image of a target object. A depth image of a target object in accordance with the depth camera 17010 is sent to the information processing apparatus 1000. The contour generation unit 1020 obtains a three-dimensional contour of the target object by using the depth image from the depth camera 17010.

In addition, in the embodiments or variations described above, no recognition is performed at all regarding who the operation point on the image belongs to, or what kind of object it is. Accordingly, for example, in a case where hands for a plurality of human users are included in an image, it is possible to set an operation point for each hand (or finger). In such a case, it is possible perform processing in response to a gesture in accordance with the motion or position of the hands of the plurality of human users. Note that a user's hand is merely an example of a target object, and by holding a feature amount of a target object (color, shape, or the like) in advance, it is possible to detect an image region of the target object from an image by using the feature amount, and, as a result, it is possible to detect a contour of the target object.

In addition, in the embodiments or variations described above, after obtaining three-dimensional positions for all points on the contour, a point that satisfies a predefined condition from among the point group on the contour is set as an operation point. However, the three-dimensional position of the operation point may be obtained after deciding a point that satisfies the predefined condition from among the point group on the contour as an operation point.

### Fourth Embodiment

In the first embodiment, a predetermined feature that becomes an operation point does not particular depend on an operation state, but if it is possible to switch a feature for obtaining an operation point in accordance with an operation state, improvement of operability is expected.

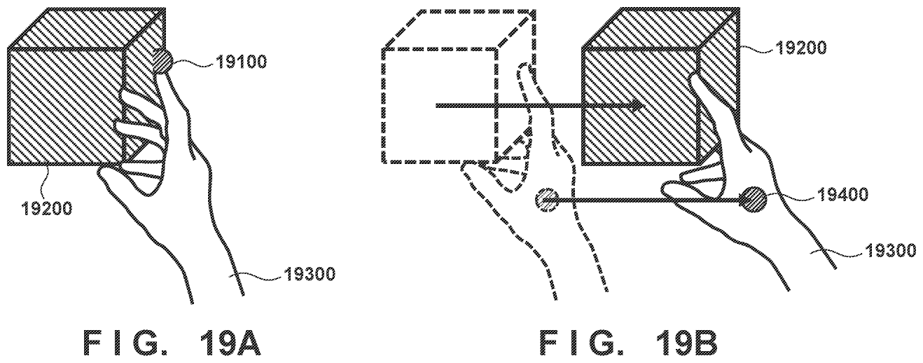

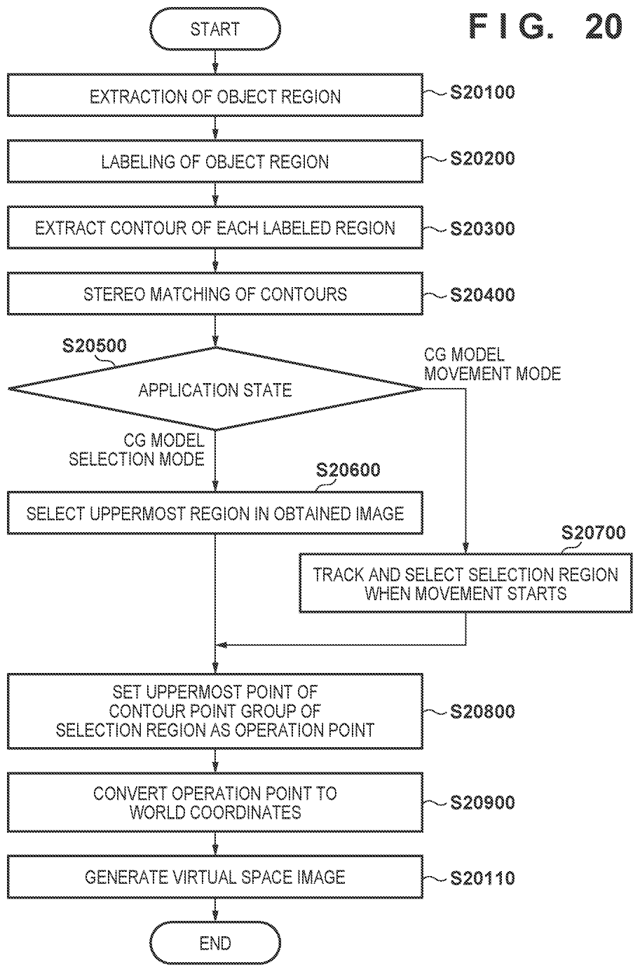

For example, when a real-space object is a hand as illustrated in FIG. 19A, it is envisioned that there are frequently cases where selection of a CG model 19200 or pressing of a CG button is performed by fingertips. Accordingly, as illustrated by FIG. 19A, it is desirable to set a feature point having coordinate values most upward in the field of view of the HMD as an operation point 19100. However, because the orientation or angle of and hand changes during operation of a CG model, rather than having the uppermost point of a hand in the field of view of the HMD be an operation point, by having the centroid or average center of the region of the hand be an operation point 19400, as illustrated in FIG. 19B, the behavior by an operation point that is not intended is reduced. In the present embodiment, description is given for a method of switching a feature for obtaining an operation point in accordance with an operation state.

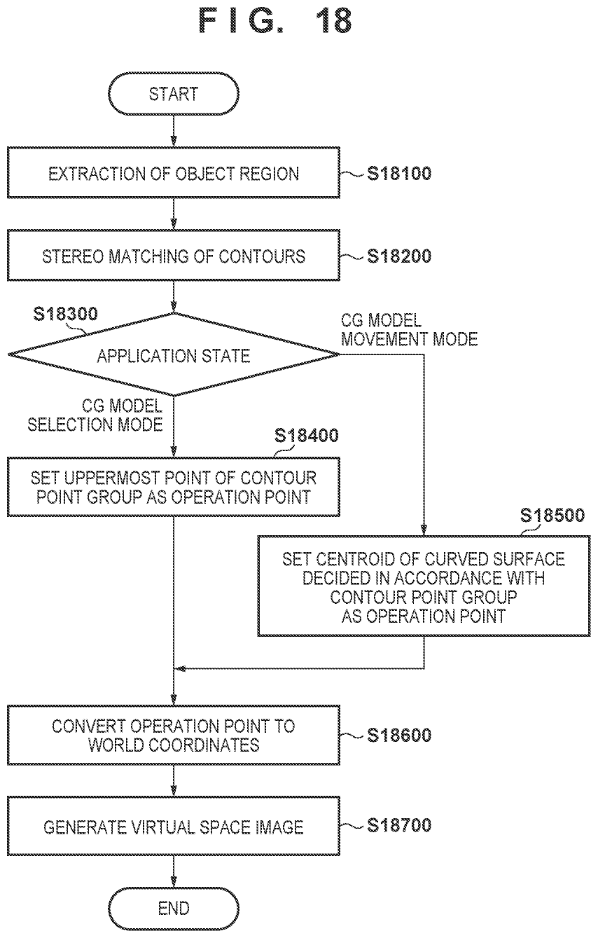

A series of processing for switching a feature that is to be an operation point in accordance with an operation state is described using the flowchart of FIG. 18.

Steps S18100 through S18200 are similar to steps S2100 through S2200 of the first embodiment, and thus description thereof is omitted.

In step S18300, the current state of the application is obtained, and subsequent processing branches in accordance with the state. In the present embodiment, the following description is given with a CG model selection mode and a CG model movement mode as examples of application states, but the application state is not limited to these.

In step S18400, operation point selection processing is executed when the application state is in the CG model selection mode. In the present embodiment, a vertex on the three-dimensional contour having coordinate values most upward in the row direction when the vertices of the three-dimensional contour obtained in step S18200 are projected onto the image obtained in step S18100 is taken as the operation point. Although a feature for calculating the operation point is not limited to this method, it is necessary to be a method that is different to the method used when the application state in step S18500 is in a different mode.

In step S18500, operation point selection processing is executed when the application state is in the CG model movement mode. In the present embodiment, the centroid of a three-dimensional curved surface region formed by the three-dimensional contour obtained in step S18200 is calculated, and set as the operation point. A feature for calculating the operation point is not limited to this, and may be the center position of vertices of the three-dimensional contour or the like.

Steps S18600 through S18700 are similar to steps S2400 through S2500 of the first embodiment, and thus description thereof is omitted.

### Fifth Embodiment

In the present embodiment, description is given for a method for switching, in accordance with an operation state, methods for selecting one real-space object for extracting an operation point when there are a plurality of real-space objects that can be operation points.

For example, in a case where a real-space object present uppermost in the field of view of the HMD is set as the single real-space object for extracting an operation point, a problem of an operation point moving to another real-space object and operability being impaired occurs when the CG model is moved downward and another real-space object becomes above the real-space object to which the operation point belonged to so far.

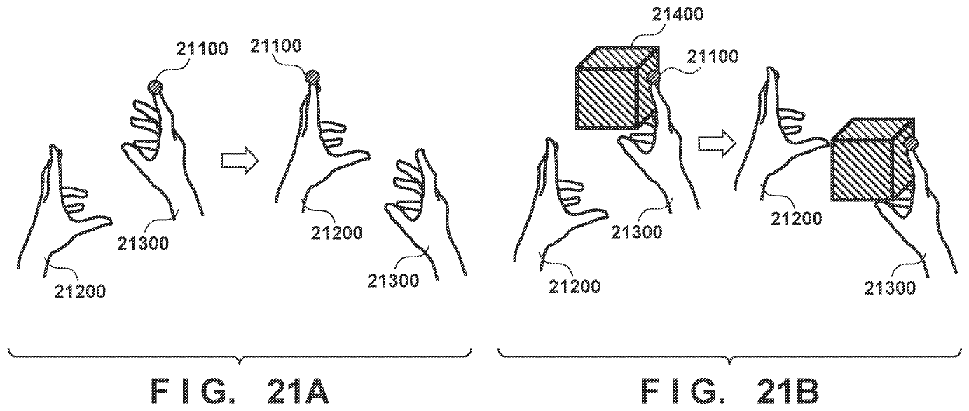

Accordingly, in the present embodiment, as illustrated by FIG. 21A, in a state where a CG model is selected, real-space objects 21300 and 21200 for which an operation point 21100 is present uppermost in a field of view of the obtained image are selected. In addition, as illustrated by FIG. 21B, when a CG model 21400 is in a state of movement, a real-space object 21300 selected when the CG model 21400 starts moving is tracked, and the real-space object 21300 is selected.

Using the flowchart of FIG. 20, description is given for a series of processing for switching, in accordance with an operation state, a method of selecting one real-space object for extracting an operation point.

Processing of steps S20100 through S20400 are similar to the processing of steps S6100 through S6400 of the second embodiment, and thus description thereof is omitted.

In step S20500, the current state of the application is obtained, and subsequent processing branches in accordance with the state. In the present embodiment, when the state of application is the CG model selection mode, the processing branches to step S20600, and when the state of the application is the CG model operation mode, the processing branches to step S20700.

In step S20600, processing for selecting a three-dimensional contour for calculating an operation point from the plurality of three-dimensional contours obtained in step S20400 is executed. In the present embodiment, when vertices of each three-dimensional contour are projected onto the image obtained in step S20100, the vertex, on a three-dimensional contour, having coordinate values most upward in the row direction is set as a comparison point. A method for obtaining a feature for calculating a comparison point is not limited to this method and may be any method. Next, from the plurality of three-dimensional contours, a three-dimensional contour to which the comparison point having coordinates most upward in the row direction belongs, is selected as a three-dimensional region for calculating an operation point. A selection method for calculating an operation point from a comparison point is not limited to the method described above, and it needs to be a different method to step S20700.

In step S20700, processing for selecting a three-dimensional contour for calculating an operation point from the plurality of three-dimensional contours obtained in step S20400 is executed. In the present embodiment, in the selection mode for selecting a CG model to be a target of movement, an event for transitioning to the movement mode for moving a CG model due to actually selecting a CG model is issued. In the movement mode, when selecting a CG model, tracking continues for the three-dimensional contour to which the operation point belongs to, and this is selected as a three-dimensional contour for calculating the operation point. A method of estimating equivalence between processing frames, in other words tracking of a three-dimensional contour, may be any method. In the present embodiment, where distances for centroids of a three-dimensional curved surface region generated in accordance with a three-dimensional contour are closest between a previous frame and a current frame are handled as the same three-dimensional contour.

In step S20800, an operation point is calculated from the three-dimensional contour selected in step S20600 or in step S20700. Specifically, the vertex on a three-dimensional contour having coordinate values most upward in the row direction in the captured image when the selected three-dimensional contour is projected onto the captured image is taken as the operation point. A feature for calculating an operation point is not limited to this method and may be any method. In addition, the feature may be changed in accordance with the operation mode, as in the fourth embodiment.

Steps S20900 through S201100 are similar to steps S6700 through S6800 of the second embodiment, and thus description thereof is omitted.

### Sixth Embodiment

Each functional unit of the information processing apparatus 1000 that is illustrated in FIGS. 1 and 17 may be implemented by hardware, and functional units other than the holding unit 1060 may be implemented by software (a computer program). In the latter case, a computer apparatus that can execute this software and has a memory that functions as the holding unit 1060 can be applied to the information processing apparatus 1000 described above.

The block diagram of FIG. 16 is used to give a description regarding an example of a hardware configuration of a computer apparatus that can be applied to the information processing apparatus 1000. Note that the hardware configuration illustrated in FIG. 16 is merely an example of a hardware configuration of a computer apparatus that can be applied to the information processing apparatus 1000.

The CPU 16200 executes various processing by using a computer program and data stored in a ROM 16300 or a RAM 16400. By this, the CPU 16200 performs operation control of the entirety of the computer apparatus, and also executes or controls, as something that the information processing apparatus 1000 performs, various processing described above.

The ROM 16300 stores a computer program or data (for example, data or a computer program for a BIOS) that does not need to be rewritten. The RAM 16400 has an area for storing data or a computer program loaded from the ROM 16300 or an external storage device 16700, or data received from outside via an input I/F 16500. Furthermore, the RAM 16400 has a work area that the CPU 16200 uses when executing various processing. With such a configuration, the RAM 16400 can appropriately provide various areas.

The input I/F 16500 functions as an interface for the input of data from outside, and, for example, various data including a captured image sent from the HMD 1100 described above is received via the input I/F 16500.

An output I/F 16600 functions as an interface for outputting data to an external apparatus, and, for example, a mixed reality space image to be output to the HMD 1100 described above is transmitted to the HMD 1100 via the output I/F 16600.

The external storage device 16700 is a large capacity information storage apparatus typified by a hard disk drive apparatus. The external storage device 16700 saves data and computer programs for causing the CPU 16200 to execute various processing described above as something that an OS (operating system) or the information processing apparatus 1000 performs. Computer programs saved in the external storage device 16700 include a computer program for causing the CPU 16200 to realize functionality of each functional unit in FIGS. 1 and 17, except for the holding unit 1060. In addition, data saved in the external storage device 16700 includes various data described as data held by the holding unit 1060, or data handled as known information in the foregoing description. In other words, the external storage device 16700 function as the holding unit 1060 described above. Data and computer programs saved in the external storage device 16700 are appropriately loaded into the RAM 16400 in accordance with control by the CPU 16200, and become a target of processing by the CPU 16200.

The foregoing CPU 16200, ROM 16300, RAM 16400, input I/F 16500, output I/F 16600, and external storage device 16700 are each connected to a bus 16100.

Note that some or all of the embodiments and variations described above may be appropriately combined, and some or all of the embodiments and variation described above may be selectively used.

### Other Embodiments

Embodiment(s) of the present invention can also be realized by a computer of a system or apparatus that reads out and executes computer executable instructions (e.g., one or more programs) recorded on a storage medium (which may also be referred to more fully as anon-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-167664, filed Aug. 31, 2017, which is hereby incorporated by reference herein in its entirety.

1. An image processing apparatus, comprising:
a selection unit configured to, out of a point group configuring a contour of a target object in a captured image, select a point satisfying a predefined condition as an operation point; and
a processing unit configured to execute processing based on the operation point.

2-20. (canceled)
